(19) United States
(12) Patent Application Publication
(10) Pub. No.: US 2026/0356042 A1
(43) Pub. Date: Nov. 12, 2026

(54) PROCESS OF RECYCLING ADDITIVELY MANUFACTURED MATERIALS

(71) Applicant: RockyTech, Ltd., Boulder, CO (US)

(72) Inventors: Alexander ZHANG, Boulder, CO (US); Yinghua JIN, Boulder, CO (US)

(21) Appl. No.: 19/475,343

(22) PCT Filed: Apr. 12, 2024
(86) PCT No.: PCT/US2024/024377

§ 371 Date: Oct. 14, 2025

Related U.S. Application Data
(60) Provisional application No. 63/459,459, filed on Apr. 14, 2023.

(51) Int. Cl. B29C 64/357; B29C 64/314; B29K 55/02; B29K 67/00; B33Y 40/00; B33Y 70/00

(52) U.S. Cl. CPC B29C 64/357; B29C 64/314; B33Y 40/00; B33Y 70/00; B29K 2055/02; B29K 2067/046

(57) ABSTRACT

A process for recycling materials resulting from an additive manufacturing process includes processing waste objects that have been additively manufactured from a plurality of thermoplastic materials having different densities into a granular thermoplastic material, dispersing the granular thermoplastic material by stirring and wetting in a solvent to form a suspension, wherein the solvent has a density between the densities of the thermoplastic materials, separating sunken and floating thermoplastic materials into a first type of thermoplastic material with a density less than the density of the solvent and a second type of thermoplastic material with a density greater than the density of the solvent, and combining the two types of thermoplastic materials.

### RELATED APPLICATIONS

This application claims priority to U.S. Patent Provisional Application Ser. No. 63/459,459, titled “Closed-Loop Materials Flow in Additive Manufacturing,” filed Apr. 14, 2023, which is incorporated herein by reference.

### BACKGROUND

Three-dimensional (3D) printing, known alternatively as additive manufacturing, is the layer-by-layer process in which digital models are used to create physical objects. 3D printing is a rapidly expanding field, with an increasing number of both consumer and industrial applications. The rising interest in 3D printing tools and technologies has fueled the increased affordability and accessibility of 3D printing devices and accessories, coupled with their novel applications in aerospace, automotive, manufacturing, robotics, and education industries. Typically, 3D printing devices require the use of a 3D printing filament for operation. Most filaments are thermoplastics that are heated in the printer's extruder configuration and extruded onto its build plate.

The most common 3D printing filament types are acrylonitrile butadiene styrene (ABS) and polylactic acid (PLA). These materials provide significant material and chemical advantages over the available alternatives at low cost. However, because these plastics are classified as type 7 (“Other”), there currently does not exist a sustainable and cost-effective method for 3D printing companies, makerspaces, and household users to dispose of waste products created from these plastics. Commonly, industries related to manufacturing and architecture use 3D printing, which allows models and prototypes to be quickly constructed. This process makes up a significant percentage of filament waste, which can result either from failed prints or rapid prototyping (where tens or even hundreds of models are made until a design is finalized). Even in fields where 3D printing is used to create finished products such as spare parts (aviation and automotive) and medical products, waste is still generated in creating the finalized design. Due to a waste rate of approximately 30-50% in the 3D printing industry, thousands of tons of 3D-printed materials are discarded annually.

Discarded 3D-printed filament cannot be processed by recycling centers and municipal programs. Not only is 3D printing filament waste difficult to recycle, but it also comes with many of the same environmental hazards posed by other types of plastic. Since PLA is a bioplastic and therefore compostable, it requires industrial composting conditions, including temperatures above 136 °F and specialized management techniques. The lack of the industrial facilities and the expensive infrastructure needed for this process results in a significant portion of PLA waste going to landfill. In a landfill, bioplastics like PLA can take hundreds of years to decompose, a process that also releases methane: a greenhouse gas 23 times more potent than carbon dioxide. ABS is a petroleum-based plastic that cannot be composted and thus will never biodegrade in the environment, causing pollution of air, water, and soil, habitat destruction, and landfill overflow.

With the increasing growth of the 3D printing market and new developments in the application of this technology, it has become essential to identify an economically viable and environmentally friendly recycling solution for plastic 3D printing filaments in order to promote the sustainable growth of additive manufacturing and the longevity of plastic 3D printed filaments.

### SUMMARY

In a first aspect, a process for recycling materials resulting from an additive manufacturing process includes processing waste objects that have been additively manufactured from a plurality of thermoplastic materials having different densities into a granular thermoplastic material, dispersing the granular thermoplastic material by stirring and wetting in a solvent to form a suspension, wherein the solvent has a density between the densities of the thermoplastic materials, separating the sunken and floating thermoplastic materials into a first type of thermoplastic material with a density less than the density of the solvent and a second type of thermoplastic material with a density greater than the density of the solvent, combining the two types of thermoplastic materials, and extruding into a filament for use in additive manufacturing.

### BRIEF DESCRIPTION OF THE FIGURES

FIG. 1 is a flowchart of a process for recycling materials resulting from an additive manufacturing process, in embodiments.

FIG. 2 is a schematic diagram of a plastic extruder, in embodiments.

FIG. 3 is a graph of average density of thermoplastic samples, in embodiments.

FIG. 4 is a graph of impact strength of thermoplastic samples, in embodiments.

FIG. 5 is a graph of average tensile modulus of thermoplastic samples, in embodiments.

FIG. 6 is a graph of average tensile strength of thermoplastic samples, in embodiments.

FIG. 7 is a graph of average extension at tensile strength for thermoplastic samples, in embodiments.

FIG. 8 is a graph of average melt flow index for thermoplastic samples, in embodiments.

### DETAILED DESCRIPTION OF THE EMBODIMENTS

Throughout the disclosure, the terms additive manufacturing and three-dimensional (3D) printing may be used interchangeably.

In embodiments, a process for recycling materials resulting from an additive manufacturing process combines a first type of thermoplastic material having a first density with a second type of thermoplastic material having a second density, wherein the first type and the second type of thermoplastic materials are not virgin materials, i.e., they have been used in an additive manufacturing process at least once. An efficient and low-cost technology produces 3D printing filaments from recycled materials with comparable if not superior mechanical properties to virgin materials, all while using minimal energy and without using additional virgin materials or additives (thus producing 100% recycled material). While existing solutions involve adding between 30-70% of virgin plastic (creating hybrid filament that results in further waste) or energy-intensive chemical recycling methods that generate more pollution and CO2 equivalents, our recycling method is both environmentally friendly and sets a new standard for sustainability in the industry.

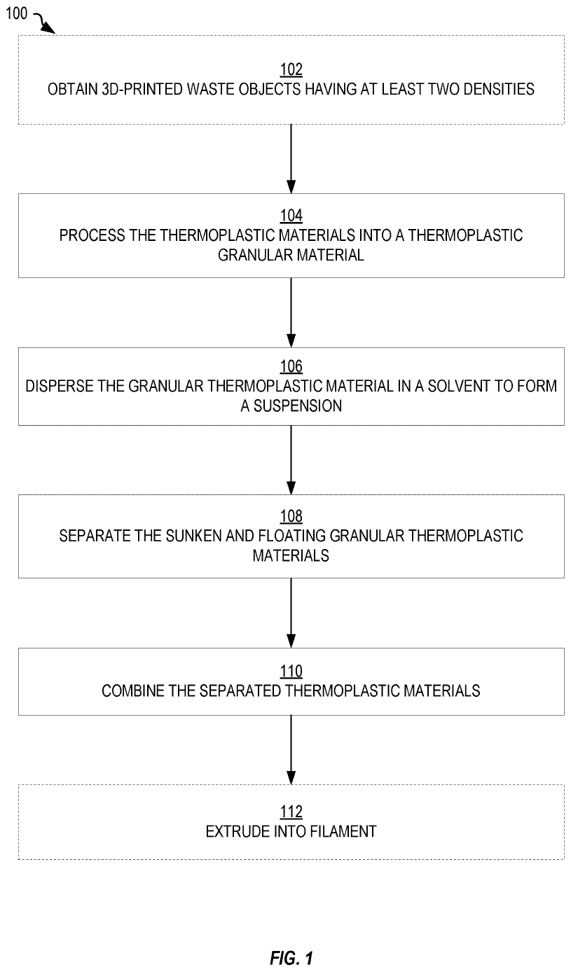

FIG. 1 is a flowchart of a method 100 for recycling materials resulting from an additive manufacturing process. Method 100 includes steps 104-110. In embodiments, method 100 also includes step 102 or step 112.

In step 102, waste objects that have been additively manufactured are obtained. In an example of step 102, the 3D-printed waste objects are of at least two types of thermoplastic materials, each type having a different density. In a representative embodiment, the at least two types are thermoplastic materials such as polylactic acid (PLA) and acrylonitrile butadiene styrene (ABS), although method 100 may make use of any two types of thermoplastic materials that have different densities. For example, obtained thermoplastics may be different colors, or may include a combination of colors in one object. Different types of thermoplastics may include other additives in addition to or instead of color dye. In step 102, several types of thermoplastic may be mixed together, both in an individual object, and in the collected objects. It is not necessary to separate the types of thermoplastic materials before the next step in the method.

In step 104, the obtained 3D-printed waste objects are processed into a granular thermoplastic material. In an example of step 104, the 3D-printed waste objects are crushed into pieces having a particle size of approximately 3-5 mm. In another example of step 104, 3D-printed waste objects may be compressed into a thin film using a heat press and then the film may be cut into smaller pieces that are less than approximately 5 mm long.

In step 106, the granular thermoplastic material is dispersed in a solvent to form a suspension. In an example of step 106, granular thermoplastic material is stirred and wetted in a solvent to form a suspension, the solvent having a density value between the average densities of the two types of thermoplastic materials. In an example of step 106 where the two types of thermoplastic materials are PLA and ABS, a sodium chloride (NaCl) solvent may be used. In embodiments, the NaCl solvent may be between an approximately 16% to 24% sodium chloride solution. In a representative embodiment, a bulk sodium chloride solution (15 L, 16 wt %) may be made by dissolving sodium chloride (2.4 kg) in water (12.6 L).

In step 108, sunken and floating thermoplastic materials in the suspension are separated into first and second types of thermoplastic materials. In an example of step 108, the suspension may be stirred for a period of time such as 5-10 minutes. When the stirring is stopped, granular thermoplastic materials with a density greater than that of the solvent sink while those with a density less than the density of the solvent float on top of the solvent. A variety of methods may be used to collect the sunken and floating fragments separately to result in first and second types of thermoplastic materials having different densities. In a representative embodiment, the separated granular thermoplastic materials may be washed one or more times to remove the residual solvent.

In step 110, the first and second types of thermoplastic materials are combined into a composite batch. In an example of step 110, ABS and PLA materials are blended into a batch including approximately 3 to 10% of the PLA material with the remainder made up of the ABS material. In embodiments, a composite batch may be formed in a variety of ways. The first and second types of thermoplastic materials may be blended, mixed, or compounded immediately after separating step 108. They may also be further processed or ground into smaller particles or a powder before blending. The first and second types of thermoplastic material may be blended in while in a power form, or may be melted before blending. In embodiments, they may also be mixed as part of an extrusion process, for example, to generate a recycled hybrid composition that may be in the form of pellets or any other form suitable for additive manufacturing. The first and second types of thermoplastic materials may be blended as part of the manufacturing process to produce a recycled hybrid filament, as explained below.

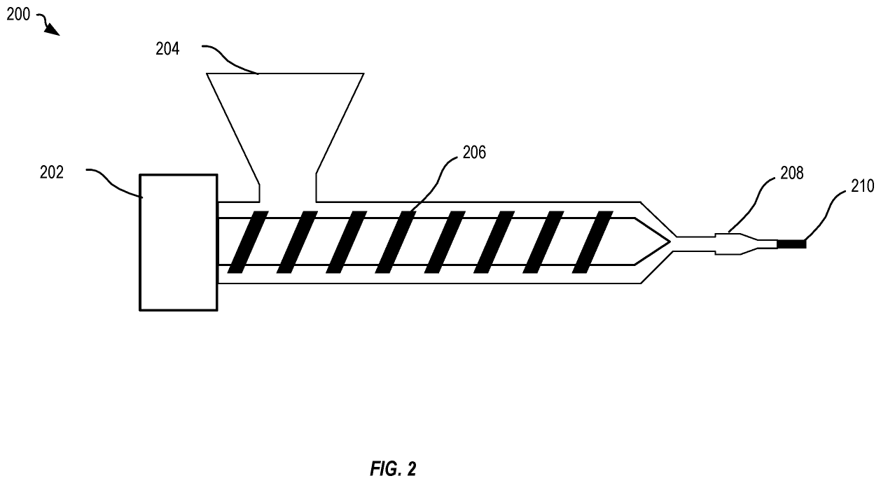

In step 112, the first and second types of thermoplastic materials are extruded into a recycled hybrid filament suitable for additive manufacturing. A single screw extruder 200, shown in the schematic diagram FIG. 2, or a twin screw extruder may be used. Other types of extruders may be used to produce a recycled hybrid filament. In a representative example to illustrate the principles of extrusion, single screw extruder 200 includes a screw 206 that is controlled by a gear box 202. Material to be extruded is added to hopper 204. The turning of screw 206 causes the material to be moved through different zones where it is heated, then extruded through die 208 to become filament 210. Other components may be included in extruder 200.

First and second types of thermoplastic materials may be combined in a single hopper where the ratio of the first type of thermoplastic to the second type of thermoplastic is between 1:33 and 1:9. They may also be separately loaded into individual hoppers, allowing for precise control over their proportions through dosing mechanisms specific to each hopper. In embodiments, a single screw or a twin screw extruder may be tuned to release the first and second types of thermoplastic materials to result in a recycled hybrid filament including approximately 3 to 10% of the first type of thermoplastic material, i.e., PLA, with the remainder made up of the second type of thermoplastic material, i.e., ABS. In embodiments, a recycled hybrid filament may be used in a 3D printer that is calibrated to ABS settings. As a representative example, a Voxelab Aquila X2 FDM 3D Printer may be calibrated to the ABS settings of a nozzle temperature of 240 °C, bed temperature of 110 °C, printing speed of 50%, and fan speed set to 0%) to achieve optimal quality prints.

The recycled hybrid filament demonstrates a significant improvement in tensile modulus when compared to the tensile modulus values of recycled PLA and ABS individually. In some cases, the tensile modulus of this hybrid filament can surpass that of virgin ABS materials, which refers to new, unused ABS filament that has not been printed. The tensile strength of the hybrid filament was comparable to recycled ABS.

### Test Methods

To illustrate principles disclosed herein, test methods will be discussed in terms of polylactic acid (PLA) and acrylonitrile butadiene styrene (ABS), which are the two most common materials used in three-dimensional (3D) printing. However thermoplastic materials may be used. Test methods included:
1. Developing an understanding of the mechanical and thermal properties of 3D-printed waste materials consisting of PLA and ABS and methods to apply the recycling process to such materials.
2. Analyzing the materials data to understand the main aspects of the current plastic recycling process and determine their feasibility in the 3D printing filament industry.

### Sample Preparation

Several different types of PLA and ABS samples were prepared. For samples with known composition, recycled objects were compressed into a thin film using a heat press and then cut into smaller pieces. To process large quantities of recycled waste with unknown composition, a mechanical crushing device such as a Techtongda™ 180 Type 220V crusher was used to break down the plastic into smaller pieces. A granular material with a particle size of approximately 3 to 5 mm was created from recycled waste.

### Density Analysis

To measure the density of each recycled PLA and ABS plastic type, uniform dog-bone-shaped samples with a length of 50 mm, a width of 5 mm, a thickness of 2 mm, and a volume of 1 mL were prepared through injection molding of the granular material at 230 °C. At least seven different types of recycled PLA and ABS materials were studied, which will be referred to with the following acronyms: rRedPLA (recycled red PLA), rPurplePLA (recycled purple PLA), rWhitePLA (recycled white PLA), rRwbMixPLA (recycled red+white+blue mix PLA), rMixPLA (a 1:1:1:1 mix of all the aforementioned recycled PLA), vPLA (clear virgin PLA), and rBlackABS (recycled black ABS). Two additional samples were prepared by separating the bulk mixture of granular material into its individual PLA and ABS components using a salt solution (discussed below). These samples were named srABS (salt-recycled ABS) and srPLA (salt-recycled PLA) for a total of at least nine different types of material.

For each material type listed above, 3-15 different samples were prepared. Although an injection molding machine may be designed to produce a known volume of 1 mL dog-bone samples using a standard mold, samples were also tested using a graduated cylinder to further validate the volume of the samples based on volume change when immersed in a solvent. This additional step was taken to confirm the precision of the volume measurements and ensure the accuracy of the results. The density of 57 samples across all nine sample groups was calculated by measuring the mass and dividing it by the known volume (1 mL), and an average density for each type of PLA samples and ABS samples was calculated.

### Selection and Preparation of Separation Medium

A solution with a density located between the average densities of PLA and ABS plastics was considered for separating the two plastics after waste materials had been processed to a granular material. To cover the available separation range between PLA and ABS, solutions with different densities were tested as shown in Table 1 below. These solutions included a sodium chloride, potassium chloride, glycerol, propylene glycol, and sugar solution. While all of these solutions were viable options, a sodium chloride (NaCl) solution was used as disclosed herein for several reasons: 1) It was cost-effective, 2) it was environmentally friendly, as it is the primary ingredient in table salt, and 3) it had a wide separation range—a 16% sodium chloride solution could effectively separate PLA and ABS just as well as a 24% sodium chloride solution could, meaning that minor changes in the concentration of sodium chloride did not affect separation capability. In embodiments, a bulk sodium chloride solution (15 L, 16 wt %) was prepared by dissolving sodium chloride (2.4 kg) in water (12.6 L).

TABLE 1

| Aqueous Solution | Density (g/mL) |
|---|---|
| 16% NaCl | 1.11 |
| 20% NaCl | 1.15 |
| 24% NaCl | 1.18 |
| 26% NaCl | 1.19 |
| 20% KCl | 1.18 |
| 50% glycerol | 1.25 |
| 60% propylene glycol | 1.16 |
| 30% sugar | 1.2 |

### Separation of Bulk PLA & ABS Recycled Mixture

The recycled mixture of PLA and ABS granular material was separated using a NaCl solution (15 L, 16 wt %) with a density of 1.11 g/mL. The crushed mixture of recycled PLA and ABS granular material was added into the salt solution and stirred for 5-10 minutes. When the stirring was stopped, PLA granular material (with a greater average density) sank to the bottom of the solution while the ABS granular material (with a lower average density) rose to the top. The separated fragments were removed from the solution with a strainer and washed up to three times to remove the residual salt. This resulted in samples of srABS (salt-recycled ABS) and srPLA (salt-recycled PLA).

### Impact Strength Testing

The samples were prepared for impact strength testing by using a heat press to compress plastic material into sheets of 5 cm×5 cm and ~1 mm thick. A device such as a Gardner Impact Tester was used to examine the impact strength of recycled PLA (rRedPLA, rPurple PLA, rWhitePLA, rRwbMixPLA, rMixPLA), virgin PLA (vPLA), and recycled ABS (rBlackABS), with ~5-10 samples for each. In a representative test, a 1 kg weight was dropped from various heights until each sample broke, eventually determining the maximum drop height for each sample. The drop height was then used to calculate the impact energy, a measure of the impact tolerance of the sample.

### Tensile Strength Testing

A total of 66 dog-bone samples across all nine sample groups (rRedPLA, rPurplePLA, rWhitePLA, rRwbMixPLA, rMixPLA, vPLA, rBlackABS, srABS, srPLA) were produced by injection molding small pieces of the recycled materials. A standard mold with known dimensions of 50 mm in length, 5 mm in width, and 2 mm in thickness was used to prepare a uniform size of samples. The tensile properties of these samples were then measured via a machine such as an Instron® 3400 electromechanical universal testing machine with a 5 kN capacity (Instron, Norwood, MA), using a ramp rate of 30 mm/min. The force required to break a specimen and its elongation to the breaking point were measured in the process of tensile testing. The extension at tensile strength [mm], load at tensile strength [N], tensile stress at tensile strength [MPa], and modulus (automatic) [MPa] were collected for each sample. Additionally, stress vs. strain data for each sample group was graphed and analyzed. Stress vs. strain graphs were created to visualize the materials' deformation in response to a tensile force, which showed key properties of the material including its elastic region, plastic region, yield point, and ultimate tensile strength. Ultimate tensile strength is the maximum stress that a material can withstand before breaking, and it was obtained by identifying the highest point on the stress-strain curve. Modulus was obtained by calculating the slope of the linear portion of the stress-strain curve, which reflects the material's stiffness. The extension at break is the strain at the point where the material breaks, which was obtained by identifying the maximum strain on the stress-strain curve.

### Melt Flow Index (MFI) Analysis

To evaluate the thermomechanical degradation of the recycled materials, the melt flow index (MFI) of vPLA, vABS, srPLA, and srABS was measured and compared. The MFI is a measure of the ease of flow of melted plastic material at a specific temperature and pressure. MFI was measured by taking a small amount of the crushed sample, heated in a barrel at a specified temperature, melted to a viscous fluid, and forced out of a capillary die by a piston actuated by a specific weight. The weight of the melted material, in grams, flowing through the capillary in 10 minutes was calculated as the melt flow index. For each sample group, approximately 10 samples were tested and the average MFI for each group was calculated. The MFI of all samples was calculated at a temperature of 230 °C, a cutting time of 10 s, and a loading weight of 2.16 kg. Equation (1) was used to calculate MFI.

MFI=M_{avg}×600/t (1)

where M_{avg}=average of the masses of each segment cut (M₁, M₂, etc.) and t=cutting time.

### Extrusion

An extrusion process to develop filaments from the recycled materials used a twin screw extruder with a 1.75 mm die to produce 3D printing filament from a granular thermoplastic material. The material was fed into a hopper and directed into the barrel of the extruder, where it was melted by a heated screw. The turning of the screw forced the mixture through the die, shaping the material into filament. Cooling fans were used to cool the filament, and it was wound around a spool for packaging.

For each sample group, the extruder was tuned to a range of 190-220 °C for PLA and 230-260 °C for ABS, and the extrusion screw speed was calibrated. The resulting filament was observed for composition and the diameter was measured to ensure consistency and good print quality. After extrusion, the filament was tested in a 3D printer to evaluate its effectiveness as a printing material.

### Data and Graphs

Table 2 is a summary of density values for all samples. Samples marked with an “*” are those where the plastic did not completely fill the mold during injection molding, therefore the volume of the sample was slightly less than 1 mL. Further, certain samples in each group are omitted; average density values are calculated based on all data.

TABLE 2

| | | | Density | Average |
|---|---|---|---|---|
| Sample Group | Sample # | Mass (g) | (g/mL) | Density (g/mL) |
| vPLA | 1 | 1.30 | 1.30 | 1.29 |
| | 2 | 1.31 | 1.31 | |
| | 3 | 1.28 | 1.28 | |
| | 4 | 1.27 | 1.27 | |
| rWhitePLA | 1 | 1.28 | 1.28 | 1.31 |
| | 2 | 1.34 | 1.34 | |
| | 3 | 1.31 | 1.31 | |
| rRedPLA | 1 | 1.39 | 1.39 | 1.38 |
| | 2 | 1.36 | 1.36 | |
| | 3 | 1.39 | 1.39 | |
| rPurplePLA | 1 | 1.36 | 1.36 | 1.35 |
| | 2 | 1.35 | 1.35 | |
| | 3 | 1.33 | 1.33 | |
| | 4 | 1.36 | 1.36 | |
| rRWBMixPLA | 1 | 1.28 | 1.28 | 1.29 |
| | 2 | 1.32 | 1.32 | |
| | 3 | 1.28 | 1.28 | |
| | 4 | 1.30 | 1.30 | |
| | 5 | 1.29 | 1.29 | |
| rMixPLA | 1 | 1.30 | 1.30 | 1.31 |
| | 2 | 1.33 | 1.33 | |
| | 3 | 1.32 | 1.32 | |
| | 4 | 1.31 | 1.31 | |
| | 5 | 1.31 | 1.31 | |
| | 6 | 1.30 | 1.30 | |
| srPLA | 1 | 1.34 | 1.34 | 1.34 |
| | 2 | 1.29 | 1.29 | |
| | 3 | 1.32 | 1.32 | |
| | 4 | 1.36 | 1.36 | |
| | 5 | 1.33 | 1.33 | |
| | 6 | 1.33 | 1.33 | |
| | 7 | 1.33 | 1.33 | |
| vABS | 1 | 0.89 | 1.01* | 1.00* |
| | 2 | 0.87 | 0.99* | |
| | 3 | 0.87 | 1.00* | |
| | 4 | 0.88 | 1.00* | |
| | 5 | 0.91 | 1.02* | |
| | 6 | 0.85 | 0.98* | |
| rBlackABS | 1 | 1.08 | 1.08 | 1.08 |
| | 2 | 1.07 | 1.07 | |
| | 3 | 1.08 | 1.08 | |
| | 4 | 1.07 | 1.07 | |
| | 5 | 1.09 | 1.09 | |
| | 6 | 1.07 | 1.07 | |
| srABS | 1 | 1.08 | 1.08 | 1.12 |
| | 2 | 1.02 | 1.02 | |
| | 3 | 1.09 | 1.09 | |
| | 4 | 1.14 | 1.14 | |
| | 5 | 1.13 | 1.13 | |
| | 6 | 1.15 | 1.15 | |
| | 7 | 1.14 | 1.14 | |
| srPLA/srABS | 1 | 1.26 | 1.26 | 1.23 |
| | 2 | 1.21 | 1.21 | |
| | 3 | 1.23 | 1.23 | |
| | 4 | 1.24 | 1.24 | |
| | 5 | 1.23 | 1.23 | |

Table 3 is a summary of impact energy values for all samples. (J) Impact energy is calculated as a function of J=m*g*h where m=mass, g=universal gravitational constant, and h=drop height. Impact strength is calculated as J/mm=force*distance where force=mass (kg)*acceleration due to gravity.

TABLE 3

| | | Sample | | | | Average |
|---|---|---|---|---|---|---|
| | Sam- | Thick- | Drop | Impact | Impact | Impact |
| | ple | ness | Height | Energy | Strength | Strength |
| Sample Group | # | (mm) | (m) | (J) | (J/mm) | (J/mm) |
| vPLA | 1 | 0.49 | 0.13 | 1.23 | 2.50 | 0.38 |
| | 2 | 0.57 | 0.09 | 0.86 | 1.51 | |
| | 3 | 0.54 | 0.05 | 0.49 | 0.91 | |
| | 4 | 0.47 | 0.10 | 0.98 | 2.09 | |
| rWhitePLA | 1 | 0.49 | 0.13 | 1.23 | 2.50 | 1.75 |
| | 2 | 0.57 | 0.09 | 0.86 | 1.51 | |
| | 3 | 0.54 | 0.05 | 0.49 | 0.91 | |
| | 4 | 0.47 | 0.10 | 0.98 | 2.09 | |
| rRedPLA | 1 | 0.88 | 0.23 | 2.26 | 2.56 | 2.80 |
| | 2 | 1.19 | 0.33 | 3.19 | 2.68 | |
| | 3 | 0.80 | 0.25 | 2.45 | 3.07 | |
| | 4 | 0.78 | 0.24 | 2.33 | 2.99 | |
| | 5 | 0.765 | 0.21 | 2.08 | 2.73 | |
| rPurplePLA | 1 | 0.50 | 0.03 | 0.25 | 0.49 | 0.66 |
| | 2 | 0.39 | 0.04 | 0.37 | 0.94 | |
| | 3 | 0.49 | 0.03 | 0.25 | 0.50 | |
| | 4 | 0.45 | 0.04 | 0.37 | 0.82 | |
| | 5 | 0.46 | 0.03 | 0.25 | 0.53 | |
| rRWBMixPLA | 1 | 0.76 | 0.15 | 1.47 | 1.94 | 1.57 |
| | 2 | 0.48 | 0.10 | 0.98 | 2.04 | |
| | 3 | 0.36 | 0.06 | 0.61 | 1.70 | |
| | 4 | 0.37 | 0.03 | 0.25 | 0.66 | |
| | 5 | 0.41 | 0.06 | 0.61 | 1.50 | |
| rMixPLA | 1 | 1.64 | 0.08 | 0.74 | 0.45 | 0.45 |
| | 2 | 1.64 | 0.07 | 0.64 | 0.39 | |
| | 3 | 1.64 | 0.11 | 1.10 | 0.67 | |
| | 4 | 1.64 | 0.08 | 0.78 | 0.48 | |
| | 5 | 1.64 | 0.09 | 0.86 | 0.52 | |
| | 6 | 1.42 | 0.06 | 0.61 | 0.43 | |
| | 7 | 1.42 | 0.06 | 0.61 | 0.43 | |
| | 8 | 1.42 | 0.06 | 0.59 | 0.42 | |
| | 9 | 1.42 | 0.05 | 0.49 | 0.35 | |
| | 10 | 1.42 | 0.05 | 0.49 | 0.35 | |
| rBlackABS | 1 | 1.54 | 0.10 | 0.98 | 0.64 | 0.80 |
| | 2 | 1.54 | 0.08 | 0.78 | 0.51 | |
| | 3 | 1.54 | 0.14 | 1.37 | 0.89 | |
| | 4 | 1.54 | 0.14 | 1.37 | 0.89 | |
| | 5 | 1.54 | 0.09 | 0.88 | 0.57 | |
| | 6 | 1.54 | 0.20 | 1.96 | 1.27 | |

Table 4 is a summary of tensile properties for all samples.

TABLE 4

| | | | | | | | Average |
|---|---|---|---|---|---|---|---|
| | | | Average | | Average | Extension | Extension |
| | | Tensile | Tensile | Tensile | Tensile | at Tensile | at Tensile |
| | Sample | Modulus | Modulus | Strength | Strength | Strength | Strength |
| Sample Group | # | (MPa) | (MPa) | (MPa) | (MPa) | (mm) | (mm) |
| vPLA | 1 | 1370.73 | 1337.68 | 61.78 | 60.94 | 2.55 | 2.71 |
| | 2 | 1379.3 | | 61.55 | | 2.72 | |
| | 3 | 1308.78 | | 60.23 | | 2.93 | |
| | 4 | 1291.91 | | 60.19 | | 2.63 | |
| rWhitePLA | 1 | 1255.75 | 1300.73 | 61.83 | 63.47 | 2.83 | 2.86 |
| | 2 | 1317.86 | | 63.23 | | 2.81 | |
| | 3 | 1328.57 | | 65.36 | | 2.93 | |
| rRedPLA | 1 | 1106.25 | 1150.55 | 58.45 | 59.40 | 2.83 | 2.82 |
| | 2 | 1153.37 | | 60.52 | | 2.84 | |
| | 3 | 1192.02 | | 59.24 | | 2.78 | |
| rPurplePLA | 1 | 1465.81 | 1495.24 | 68.95 | 64.44 | 2.61 | 3.01 |
| | 2 | 1474.66 | | 65.74 | | 3.40 | |
| | 3 | 1488.60 | | 60.28 | | | |
| | 4 | 1551.88 | | 62.79 | | | |
| rRWBMixPLA | 1 | 1391.04 | 1363.78 | 64.69 | 61.65 | 2.52 | 2.51 |
| | 2 | 1394.29 | | 62.95 | | 2.70 | |
| | 3 | 1358.88 | | 62.99 | | 2.52 | |
| | 4 | 1348.79 | | 59.65 | | 2.36 | |
| | 5 | 1325.9 | | 57.96 | | 2.47 | |
| rMixPLA | 1 | 1318.61 | 1351.52 | 51.33 | 51.35 | 2.46 | 2.38 |
| | 2 | 1295.48 | | 45.64 | | 2.33 | |
| | 3 | 1411.76 | | 62.70 | | 2.59 | |
| | 4 | 1367.71 | | 53.75 | | 2.35 | |
| | 5 | 1389.33 | | 57.02 | | 2.35 | |
| | 6 | 1326.25 | | 37.63 | | 2.17 | |
| srPLA | 1 | 1345.50 | 1307.76 | 61.36 | 60.58 | 3.20 | 3.32 |
| | 2 | 1425.11 | | 61.87 | | 2.79 | |
| | 3 | 750.94 | | 62.13 | | 3.66 | |
| | 4 | 1221.25 | | 61.54 | | 3.81 | |
| | 5 | 1310.30 | | 61.97 | | 3.54 | |
| | 6 | 1304.45 | | 59.94 | | 2.90 | |
| | 7 | 1235.56 | | 54.74 | | 3.17 | |
| | 8 | 1441.59 | | 62.43 | | 3.56 | |
| | 9 | 1448.27 | | 62.77 | | 3.51 | |
| | 10 | 1483.64 | | 61.04 | | 3.09 | |
| | 11 | 1389.91 | | 57.27 | | | |
| | 12 | 1336.58 | | 59.87 | | | |
| vABS | 1 | 2358.00 | 2281.15 | 58.55 | 58.43 | 1.58 | 1.69 |
| | 2 | 2227.42 | | 59.81 | | 1.88 | |
| | 3 | 2299.82 | | 59.32 | | 1.88 | |
| | 4 | 2346.80 | | 51.62 | | 1.56 | |
| | 5 | 2258.45 | | 61.61 | | 1.68 | |
| | 6 | 2196.38 | | 59.69 | | 1.58 | |
| rBlackABS | 1 | 1021.54 | 1007.61 | 48.79 | 45.87 | 3.06 | 2.85 |
| | 2 | 1019.87 | | 46.40 | | 2.94 | |
| | 3 | 1034.22 | | 46.71 | | 2.82 | |
| | 4 | 997.58 | | 47.16 | | 2.91 | |
| | 5 | 1007.58 | | 44.85 | | 2.85 | |
| | 6 | 964.86 | | 41.29 | | 2.52 | |
| srABS | 1 | 933.28 | 999.39 | 39.21 | 39.79 | 2.91 | 3.09 |
| | 2 | 1041.73 | | 41.72 | | 3.41 | |
| | 3 | 969.33 | | 32.85 | | 3.11 | |
| | 4 | 904.74 | | 40.19 | | 3.46 | |
| | 5 | 645.61 | | 35.24 | | 2.95 | |
| | 6 | 1003.70 | | 41.78 | | 3.61 | |
| | 7 | 1028.45 | | 41.37 | | 3.11 | |
| | 8 | 1002.15 | | 39.82 | | 2.79 | |
| | 9 | 960.32 | | 32.50 | | 2.84 | |
| | 10 | 959.88 | | 41.00 | | 2.76 | |
| | 11 | 953.07 | | 43.49 | | 3.26 | |
| | 12 | 932.47 | | 38.89 | | 2.87 | |
| | 13 | 971.60 | | 39.82 | | | |
| | 14 | 1027.60 | | 43.37 | | | |
| | 15 | 1671.46 | | 42.22 | | | |
| | 16 | 984.89 | | 43.17 | | | |
| srPLA/srABS | 1 | 2544.01 | 2559.58 | 40.7 | 38.59 | 1.33 | 1.38 |
| | 2 | 2565.08 | | 38.66 | | 1.22 | |
| | 3 | 2575.07 | | 34.94 | | 1.71 | |
| | 4 | 2554.15 | | 40.07 | | 1.25 | |

Table 5 is a summary of the melt flow index (MFI) for all samples. MFI is calculated according to the equation MFI=M_avg*600/t where t=current time (10 s).

TABLE 5

| | | | | | | | | | | Average |
|---|---|---|---|---|---|---|---|---|---|---|
| | | | | | | | | | Melt | Melt |
| Sample | Sample | | | | | | | | Flow | Flow |
| Group | # | M_1 | M_2 | M_3 | M_4 | M_5 | M_6 | M_Avg | Index | Index |
| vPLA | 1 | 0.184 | 0.309 | 0.229 | 0.266 | 0.252 | 0.244 | 0.258 | 15.48 | 22.97 |
| | | 0.331 | 0.273 | 0.233 | | | | | | |
| | 2 | 0.317 | 0.336 | 0.280 | 0.323 | 0.303 | 0.314 | 0.264 | 15.84 | |
| | | 0.215 | 0.176 | 0.194 | 0.186 | | | | | |
| | 3 | 0.463 | 0.429 | 0.313 | 0.446 | 0.474 | 0.420 | 0.431 | 25.86 | |
| | | 0.437 | 0.460 | 0.439 | | | | | | |
| | 4 | 0.569 | 0.528 | 0.59 | 0.545 | 0.596 | 0.598 | 0.578 | 34.68 | |
| | | 0.600 | 0.600 | 0.658 | 0.675 | 0.324 | 0.652 | | | |
| rPLA | 1 | 0.387 | 0.393 | 0.416 | 0.525 | 0.377 | 0.527 | 0.474 | 28.44 | 30.24 |
| | | 0.484 | 0.521 | 0.629 | 0.449 | 0.531 | 0.449 | | | |
| | 2 | 0.518 | 0.613 | 0.354 | 0.52 | 0.752 | 0.574 | 0.555 | 33.30 | |
| | 3 | 0.547 | 0.489 | 0.598 | 0.579 | 0.571 | 0.434 | 0.483 | 28.98 | |
| | | 0.318 | 0.453 | 0.427 | 0.488 | 0.455 | 0.438 | | | |
| vABS | 1 | 0.075 | 0.067 | 0.071 | 0.076 | 0.087 | 0.082 | 0.084 | 5.04 | 3.83 |
| | | 0.092 | 0.086 | 0.072 | 0.094 | 0.097 | 0.106 | | | |
| | 2 | 0.062 | 0.065 | 0.065 | 0.063 | 0.065 | 0.068 | 0.064 | 3.84 | |
| | | 0.061 | 0.059 | | | | | | | |
| | 3 | 0.068 | 0.067 | 0.067 | 0.066 | 0.069 | 0.066 | 0.067 | 4.02 | |
| | | 0.066 | 0.069 | | | | | | | |
| | 4 | 0.069 | 0.066 | 0.066 | 0.061 | 0.059 | 0.060 | 0.064 | 3.84 | |
| | | 0.059 | 0.064 | 0.066 | 0.067 | | | | | |
| | 5 | 0.057 | 0.055 | 0.055 | 0.063 | 0.062 | 0.122 | 0.064 | 3.84 | |
| | | 0.053 | 0.063 | 0.063 | 0.063 | 0.052 | 0.061 | | | |
| | 6 | 0.053 | 0.053 | 0.052 | 0.053 | 0.056 | 0.060 | 0.054 | 3.24 | |
| | | 0.057 | 0.051 | 0.052 | 0.051 | | | | | |
| | 7 | 0.052 | 0.051 | 0.052 | 0.063 | 0.060 | 0.061 | 0.057 | 3.42 | |
| | 8 | 0.054 | 0.055 | 0.056 | 0.058 | 0.060 | 0.059 | 0.056 | 3.36 | |
| | | 0.059 | 0.056 | 0.051 | 0.054 | 0.056 | 0.056 | | | |
| rABS | 1 | 0.233 | 0.167 | 0.194 | 0.2 | 0.239 | 0.33 | 0.264 | 15.84 | 11.96 |
| | | 0.375 | 0.32 | 0.315 | 0.258 | 0.282 | 0.25 | | | |
| | 2 | 0.119 | 0.305 | 0.18 | 0.093 | 0.185 | 0.162 | 0.171 | 10.26 | |
| | | 0.174 | 0.153 | | | | | | | |
| | 3 | 0.165 | 0.154 | 0.163 | 0.177 | 0.167 | 0.184 | 0.163 | 9.78 | |
| | | 0.135 | 0.192 | 0.186 | 0.189 | 0.14 | 0.103 | | | |

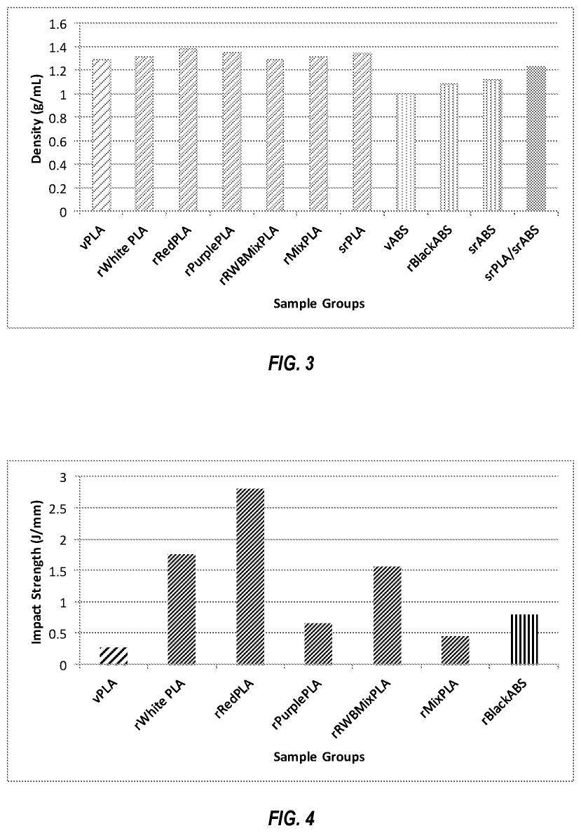

As shown in Table 2 and FIG. 3, the densities of recycled PLA and recycled ABS are approximately 1.27-1.39 g/cm³ and 1.07-1.09 g/cm³, respectively. To separate the two materials, a separation medium was chosen from various solutions that had densities within the separation range, for example, 1.15-1.25 g/mL. In embodiments, a sodium chloride (NaCl) solution has a wide separation range and is cost-effective and eco-friendly. An aqueous solution containing 16-24% sodium chloride exhibits a density range of 1.11-1.19 g/m, indicating that evaporation of water and an increase in concentration would not significantly affect the separation result. This solution is efficient and rapid in separating large quantities of PLA and ABS, with minimal environmental and economic impacts. When PLA and ABS scraps were mixed into the 16% sodium chloride solution (with a density of 1.11 g/mL), PLA sank to the bottom of the container while all of the ABS floated to the top.

As noted above, other recycled materials with different densities may be separated used with a different solution as long as the density of the solution is between the densities of the recycled materials.

Following sample separation and preparation, the physical properties of various recycled PLA and ABS were measured and analyzed. As shown in Table 3 and FIG. 4, the impact strength data exhibited significant variation between different types/colors of the recycled PLA. However, the impact strength of recycled PLA samples was typically higher than virgin PLA (vPLA) and the mixture of recycled PLA (rMixPLA) displayed comparable impact strength to virgin PLA (vPLA). These findings demonstrate that while additives (dyes, cosmetic additions, and chemical compounds) can affect the physical strength of recycled PLA materials, mixing a combination of different types of the recycled PLA plastics together provides a similar impact strength to the virgin material. Because rMixPLA (average 0.45 J/mm) demonstrated similar or even slightly higher impact strength when compared to that of vPLA (average 0.38 J/mm), various colors of PLA may be blended, eliminating the need to separate them based on their individual colors.

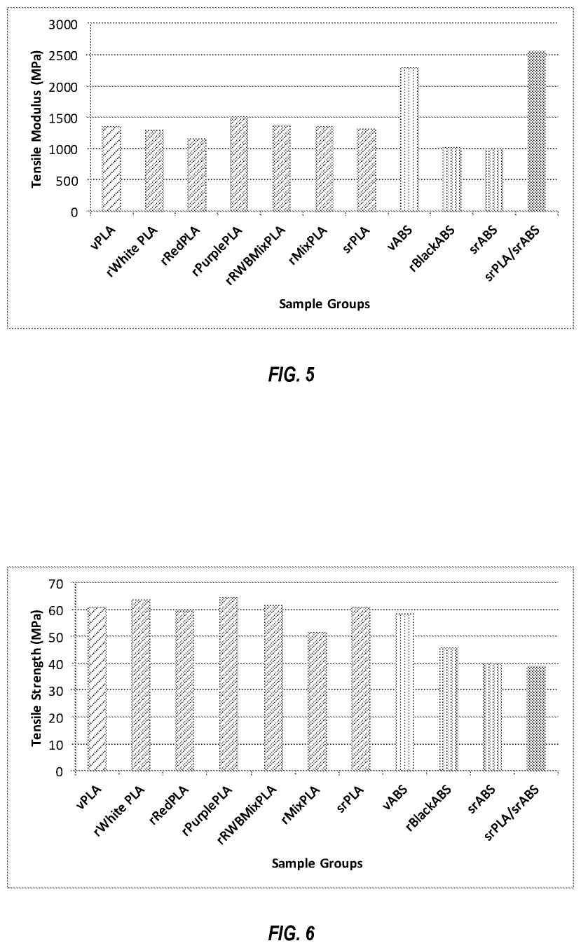

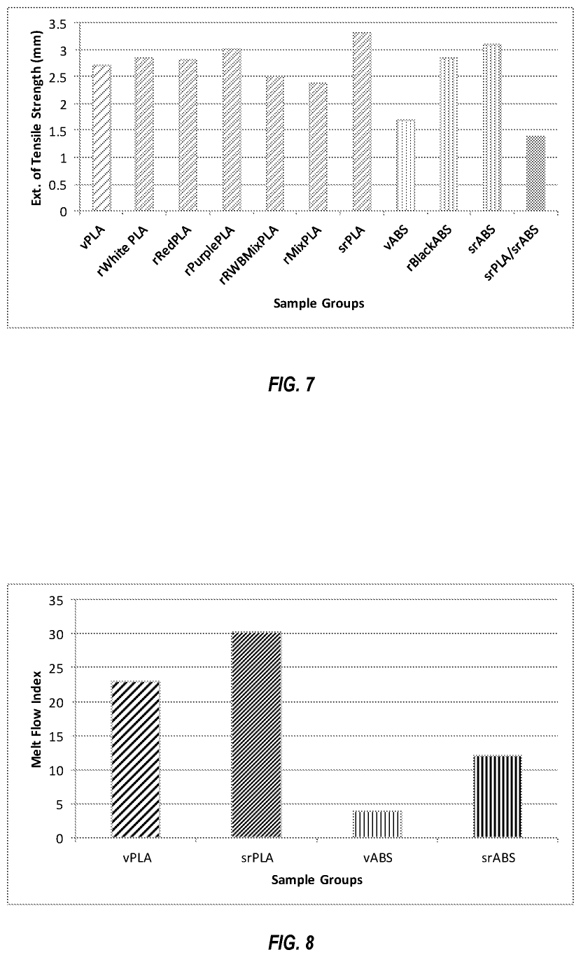

As shown in Table 4, tensile strength data demonstrates that recycled PLA maintains similar tensile properties to virgin PLA while recycled ABS had significantly different tensile properties compared to virgin ABS. FIGS. 5-7 show average values of tensile modulus, tensile strength and extension of tensile strength for sample types. The average tensile modulus of rMixPLA (1352 MPa) is comparable to that of vPLA (1338 MPa), indicating relatively constant elastic properties before and after printing. In contrast, the average tensile modulus of rABS (999-1008 MPa) is considerably lower than that of vABS (2281 MPa). Similar trends were observed for tensile strength and extension at tensile strength, with ABS experiencing significant degradation and PLA maintaining consistent properties. The average tensile strength of rMixPLA (51 MPa) is lower than that of vPLA (61 MPa). Similarly, rABS (40-46 MPa) also demonstrates considerably lower tensile strength than vABS (58 MPa). The average extension at tensile strength of rMixPLA (2.38 mm) is similar to that of vPLA (2.71 mm), while rABS (2.85-3.09 mm) demonstrates considerably higher extension at tensile strength than vABS (1.69 mm).

These results show that while rPLA exhibits comparable tensile modulus, elasticity, and tensile strength to vPLA, it can withstand as much deformation before breaking as its virgin counterpart. On the other hand, rABS demonstrated significantly lower tensile modulus, elasticity, and tensile strength compared to vABS. However, interestingly, although it is less resistant to force before deformation and/or fracture compared to vABS, it can tolerate higher deformation before breaking.

As shown in Table 5 and FIG. 8, Melt Flow Index (MFI) analysis may be conducted on the sample groups of srPLA, srABS, vPLA, and vABS to measure processability and quality control. Both srPLA and srABS have much higher melt flow indexes than their virgin counterparts, demonstrating significant thermomechanical degradation after being printed. The MFI of srPLA (30.24) is higher than that of vPLA (22.97), and the MFI of srABS (11.96) was considerably higher than that of vABS (3.83). This suggests that recycled materials flow at a higher rate when melted and may require changes in printer settings to accommodate for the differences in flow. Furthermore, the thermomechanical degradation experienced by both recycled PLA and ABS means that reprinting these filaments alone is likely to result in poor-quality downcycled material.

Testing the impact strength, tensile strength, and MFI of these materials reveals notable differences in their mechanical properties. Impact strength testing demonstrated that a mixture of recycled PLA yields comparable impact strength to virgin plastics, making it unnecessary to sort mixtures of recycled plastics by type and/or color. While recycled PLA exhibits similar tensile properties to virgin PLA (tensile modulus and tensile strength), recycled ABS experiences significant degradation in tensile properties. MFI testing reveals that both PLA and ABS undergo severe thermomechanical degradation after being printed.

Plastic extrusion is a manufacturing process in which a thermoplastic material—in the form of pellets, powder, or granulates—is fed into a hopper and directed into the barrel of an extruder. A heated screw melts the materials in the barrel. Once melted, the turning of the screw forces the mixture through a die—a specialized machine tool to shape the material. After shaping, the material is cooled to produce the final product. To produce 3D printing filament, a circular output die may be fitted to an extruder, which allows for precise control over the diameter of the filament. The diameter of the output die and therefore the filament may vary. The two most common diameters are 1.75 mm and 2.85 mm. Once the plastic is extruded through the output die, cooling fans are used to cool the filament, allowing it to solidify and maintain its shape. The result is a long continuous strand of extruded plastic that may be wound around a spool.

In embodiments, a mixture of srPLA and srABS in a ratio of approximately 3-10% srPLA provides a recycled filament suitable for 3D printing. We tested various ratios of srPLA and srABS by tuning the input screw speeds. After many unsuccessful attempts, further research and experimentation led us to determine a certain ratio containing a small percentage of srPLA mixed into a majority srABS batch. This specific ratio yielded high-quality filament that could be printed efficiently and create objects which, in their finalized stage, exhibited comparable characteristics to those made from virgin materials. Following the successful outcomes achieved with the hybrid filament, we conducted further tensile testing on the srPLA/ABS hybrid to determine the technical potential of its prints. As shown in FIGS. 5-7, the hybrid filament exhibited an impressive modulus of 2559.58 MPa, surpassing that of both vPLA (1337.68 MPa) and vABS (2281.15 MPa). This indicates that prints produced with srPLA/ABS hybrid filament are capable of withstanding higher levels of force before deformation. Although the tensile strength and extension at tensile strength of the hybrid filament were lower than those of virgin PLA and virgin ABS, it still exhibited a respectable tensile strength of 38.59 MPa. In summary, the srPLA/ABS hybrid filament may be an excellent alternative to virgin PLA and virgin ABS, especially in applications where impact resistance and durability are essential.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A process for recycling materials resulting from an additive manufacturing process, comprising:
processing waste objects that have been additively manufactured from a plurality of thermoplastic materials having different densities into a granular thermoplastic material;
dispersing the granular thermoplastic material by stirring and wetting in a solvent to form a suspension, wherein the solvent has a density between the densities of the granular thermoplastic materials so that some of the granular thermoplastic material sinks and some floats;
separating the sunken and floating granular thermoplastic materials into a first type of thermoplastic material with a density greater than the density of the solvent and a second type of thermoplastic material with a density less than the density of the solvent; and
combining the first and second types of thermoplastic materials.

2. The process of claim 1, wherein combining further comprises combining the first and second types of thermoplastic materials in a weight ratio of the first type of thermoplastic to the second type of thermoplastic is between 1:33 and 1:9.

3. The process of claim 1, further comprising extruding the combined thermoplastic materials into a filament for use in additive manufacturing.

4. The process of claim 1, wherein the first type of thermoplastic material is polylactic acid (PLA).

5. The process of claim 4, wherein the PLA includes dyes, cosmetic additives or other chemical compounds.

6. The process of claim 1, wherein the second type of thermoplastic material is acrylonitrile butadiene styrene (ABS).

7. The process of claim 1, wherein the granular material is material resulting from an additive manufacturing process that has been crushed.

8. The process of claim 7, wherein the granular material has a particle size of 3-5 mm.

9. The process of claim 1, wherein the granular material is material resulting from an additive manufacturing process that has been compressed into a thin film and cut into pieces.

10. The process of claim 1, wherein the solvent has a density between the first density and the second density.

11. The process of claim 1, further comprising, after straining the suspension, washing the separated thermoplastic materials to remove the solvent.

12. A composition of material for additive manufacturing, comprising:
a first quantity of a first type of thermoplastic material resulting from an additive manufacturing process with a first density; and
a second quantity of a second type of thermoplastic material resulting from an additive manufacturing process with a second density;
wherein a ratio of the first quantity to the second quantity is approximately between 1:33 and 1:9 by weight.

13. The material of claim 12, wherein the first type of thermoplastic material is recycled polylactic acid (PLA).

14. The material of claim 13, wherein the recycled PLA includes dyes, cosmetic additives or other chemical compounds.

15. The material of claim 13, wherein the first quantity of PLA includes PLA having different dyes, cosmetic additives or other chemical compounds.

16. The material of claim 12, wherein the second type of thermoplastic material is recycled acrylonitrile butadiene styrene (ABS).
